(19) United States
(12) Patent Application Publication
(10) Pub. No.: US 2012/0125906 A1
(43) Pub. Date: May 24, 2012

(54) THERMALLY ISOLATED HEATED PIPELINE MADE OF DOUBLE CASING SECTIONS AND LAYING PROCESS FOR SUCH A PIPELINE

(75) Inventors: Christian GEERTSEN, Versailles (FR); Wayne P. GROBBELAAR, Boulogne Billancourt (FR)

(73) Assignee: ITP SA, Louveciennes (FR)

(21) Appl. No.: 13/279,723

(22) Filed: Oct. 24, 2011

(30) Foreign Application Priority Data
Nov. 18, 2010 (FR) 10.04481

(51) Int. Cl. H05B 3/02; F16L 1/26; H05B 1/00

(52) U.S. Cl. 219/201; 405/170

(57) ABSTRACT

A section of a pipeline for the transport of hydrocarbons that is adapted to a sub-sea environment, said section being constituted by at least one double casing comprising one external casing and one internal casing between which an annular space is arranged comprising a thermally insulating material, wherein said section comprises at least one heating circuit arranged in said annular space and a connection base fixed to the external casing and intended to a connection plug linked to an external electric power cable, the connection base closing an access passage in communication with said annular space, the heating circuit being electrically powered by the connection base forming a closed heating electrical circuit to heat the section.

### BACKGROUND OF TH INVENTION

1. Field of the Invention

The technical scope of the present invention concerns hydrocarbons transport pipes equipped with heating means, namely to maintain the temperature of the hydrocarbons.

2. Description of the Related Art

It is known that pipes for the transport of hydrocarbons, also known as pipelines, can be heated using different heating modes. Pipelines installed underwater are namely heated electrically to avoid any solid blockages, also called plugs, forming within the hydrocarbons. The electrical heating enables the temperature within the pipe to be maintained at 20° C. or more which is the temperature at which gas hydrates appear in typical pressure conditions for subsea oil wells (several tens to several hundreds of bars), or even at a temperature higher than 30, 40 or even 60° C. if the fluid incorporates paraffin having high solidification temperatures.

Electrical heating may be used in several ways. A magnetic field may be created so as to heat the pipe thanks to the eddy currents created in the pipe walls. Such a heating method is namely described in patent EP-0441814. One disadvantage of the method taught by patent EP-0441814, which requires a second casing, is that it cannot be associated with high efficiency insulation (thermal exchange coefficient, called “U” between a fluid vein and the subsea environment is less than 2 or even less than 1 W/(m².K)). This second casing is made of carbon steel and actually forms an electromagnetic screen and prevents the main pipe, formed by the first inner casing, from being heated.

According to another method, a current may be directly injected in the metallic wall of the pipe as described by patent U.S. Pat. No. 3,293,407. The electrified wall of the pipe may, however, become a hazard in those places where an operator is able to access the pipe. Additionally, any current leakage in the water surrounding the pipeline will cause the corrosion and premature deterioration of the pipe.

Patent EP-1461559 describes a double-walled pipe heated by Joule effect via electric heating cables. The use of a double-walled pipe associated with an insulator enables thermal exchanges to be reduced to the above-mentioned level (U less than 2 or even 1 W/(m².K)) and makes it possible to heat great lengths of pipeline at moderate power of about 3 to 50 W/m².

However, the double-walled pipeline described in EP1461559 relates to so-called reeled pipe technology. This technique is mostly advantageous when installing small diameter pipes, the length of pipe being short enough not to exceed the carrying capacity of the laying vessel.

Such a laying technique is thus essentially used for pipelines to be laid over short distances, for example a few tens of kilometers at most, and where the bending stiffness of the pipes is compatible with the deformation capacities of the coiling and uncoiling system of the laying vessel. The bending moment to plastically deform the hydrocarbon pipeline is, in fact, proportional to its thickness multiplied by its diameter squared.

The combination of the double-walled pipeline with resistive heating is advantageous in terms of compactness and energetic efficiency since it enables high performance thermal insulation to be combined with a uniform distribution of heat using electric wires of small diameter.

When the reeled pipe has been unreeled, the empty vessel must return to port to load another reel. The vessel loaded with the new reeled pipe must then return to the laying site and recover the part of the pipeline already laid so as to make a junction and then unreel the new pipe.

For important distances, the so-called S or J laying techniques are more advantageous, or the only ones possible for large diameter pipes. These laying techniques consist in assembling on the laying vessel of short straight sections, measuring from 12 to 72 m for example, so as to build the required length of pipeline. The sections may be laid horizontally (S-lay) or vertically (J-lay) for their assembly.

Another drawback to the heated pipeline disclosed by EP1461559 lies in that in case of breakdown in the heating circuit located at a determined place in the double-walled pipeline, the heating of the pipeline is completely cut off downstream of the breakdown.

### SUMMARY OF THE INVENTION

The aim of the present invention is to overcome one or several of the drawbacks of prior art by providing a pipeline section installed by the S-lay or J-lay method, wherein the thermal insulation and heating of the pipeline are optimized.

This objective is attained thanks to a section of a pipeline for the transport of hydrocarbons that is adapted to a sub-sea environment, said section being constituted by at least one double casing comprising one external casing and one internal casing between which an annular space is arranged comprising a thermally insulating material, wherein said section comprises at least one heating circuit arranged in said annular space and a connection base fixed to the external casing and intended to a connection plug linked to an external electric power cable, the connection base closing an access passage in communication with said annular space, the heating circuit electrically powered by the connection base forming a closed heating electrical circuit to heat the section.

Indeed, it is important to use an S or J laying technique for such a transport pipe combining resistive electrical heating with excellent thermal insulation, since the reduction of the offshore electrical consumption generates a lot of savings.

According to one characteristic of the invention, the annular space is closed and sealed, this annular space being pressurized at a predetermined pressure level optimized for thermal insulation.

Advantageously, the annular space is pressurized to said optimized predetermined pressure at a pressure level less than the atmospheric pressure.

According to one characteristic of the invention, the heating circuit which comprises for example electric heating lines, is electrically isolated from the external casing and from the internal casing.

The sections enable offshore linking by welding the internal pipe, the external casing of the sections not being welded together and the bending stiffness and thermal insulation around the weld being reinforced by the installation of a rigid insulating sleeve.

According to another particularity of the invention, the heating circuit arranged in the annular space of the section is intended to be powered in parallel by the electrical power cable external to the section.

A distinction is made namely between the heating lines internal to the sections and the power lines external to the sections.

According to another particularity of the invention, the heating circuit comprises a heating loop for heating by Joule effect and intended to be powered in single-phase mode by the external power cable.

According to another particularity of the invention, the heating circuit comprises three heating lines delta or star connected to each other and powered in three-phase mode by the external power cable.

The three-phase external power cable can comprise three power lines and possibly one or several additional lines for the neutral. A single-phase heating circuit may be powered in the single-phase mode by a single-phase or three-phase external power cable. Two lines of a three-phase power cable are, for example, used for a single-phase heating circuit.

A person skilled in the art will recognize numerous variants leading to a globally balanced wiring diagram, for example by linking three successive sections to different phases of the external power cable and this along the whole pipeline.

According to another particularity, the section is intended to be assembled by welding the internal casing, with two adjacent sections, its heating circuit enabling heating by conduction of a zone around this weld According to another particularity of the invention, said connection base is associated with an element to cut the power supply in case of a short circuit occurring in said annular space.

According to anther particularity of the invention, the section comprises redundant heating circuits to exclusively heat said section, these heating circuits being electrically powered by said connection base or by several connection bases associated with several access passages in communication with the annular space, each of these connection bases closing one of these passages.

According to another particularity of the invention, the heating circuit requires a power supply of between 5 and 50 W/m² to maintain its temperature. Higher wattages may be required for short periods to heat up the piping quickly. To calculate the power to be supplied, the power is referenced to the surface of the internal or external pipe of the double-walled pipeline (the two surfaces can be taken into account depending on practice).

According to another particularity of the invention, the thermal exchange coefficient of the section is in the range of 0.1 to 2 W/(m².K).

Another object of the present invention is that of a pipeline for the transport of hydrocarbons composed of straight sections welded together on a laying vessel, said pipeline comprising a plurality of heated sections according to the invention, these heated sections comprising their electrical heating circuit connected in parallel to said external electrical power cable.

According to another particularity of the invention, the heat is distributed in the pipeline by means for distributing heat between the heated sections and their neighboring non-heated sections. Heat distribution is, for example, performed by bubbling gas through the pipeline or by macroscopic movement of the fluids due to natural convection. Gas or another fluid is, for example, introduced from one end of the pipe. A heated section may, for example, become non-heated in the event of a breakdown. There may also be a pipe in which each of the sections is heated according to the invention. Redundant heating circuits are provided, for example.

According to another particularity of the invention, the connection plug linked to the external power cable is arranged at the end of a branch electrically connected to lines of the external power cable by an element cutting off the power supply in the case of a short circuit downstream of the branch.

According to another particularity of the invention, the external power cable is supplied by a generator, the electrical resistance of the heating circuit in one of the sections has a value that decreases according to its distance from the generator. The generator can deliver an alternating current or a direct current, according to the requirements.

According to another particularity of the invention, the external power cable is supplied with a voltage in the range of 5 to 1 kV.

Another object of the present invention relates to a process to lay a pipeline according to the invention, wherein:
a section is positioned horizontally or vertically on a laying vessel,
this section is welded to a part of the pipeline already assembled,
a thermally insulating sleeve is slipped on over the weld,
a quick set material is injected into a volume located between the two sections and under the sleeve,
the connection base is connected to a branch of the external power cable.

A first advantage of the present invention derives from the fact that this laying process is adapted to S and J pipeline laying methods without the necessity of making electrical welding all along an electrical path arranged in a continuous annular space and over the full length of the double-walled pipe.

The invention is clearly differentiated from techniques of prior art in that it would be difficult or even impossible to provide serial electrical connections for each section according to prior art using techniques to assemble short sections in the aim of creating a continuous annular space wherein the electrical wiring is installed. Remaining in the hypothesis of an assembly of short sections aiming to recreate a continuous annular space, for a pipeline of several tens of kilometers, firstly the risk of defects would be too high and secondly a cumulative voltage drop corresponding to the contact resistances of the serial electrical connections would appear.

Another advantage of the present invention lies in the fact that the electrical resistor in each section can be adapted thereby enabling each section to be powered optimally.

Another advantage of the present invention lies in that the parallel electrical connection of the heating circuits of the pipeline makes it more robust in view of any defects or breakdowns, since the power failure of the heating lines in one section will only affect the section in question and will not affect the heating function of adjacent sections. Moreover, the failure of one heating circuit may be compensated by the adjacent sections, since, under the effect of conduction and convection, heat will be transmitted to the defective section. This is important, namely, in the case of a production stop. By increasing the mean power supplied, it is also possible to compensate for a local loss of heating in one section.

Heat transmission can also be improved by facilitating the movement of fluids in the pipeline. Thus, during a production stop during which the line remains pressurized, the inlet valve may be opened for a short time to induce movement of the fluids or to facilitate their movement, by bubbling of gases from one end of the pipe.

Another advantage of the present invention lies in that the diameter of the heated double-walled pipes does not constitute a limitation in the laying of these pipes. The pipe according to the invention is namely adapted for section with a diameter greater than or equal to 400 mm. The diameter of sections may be, for example, in the range of 200 mm to 600 mm or above.

### BRIEF DESCRIPTION OF THE DRAWING

Other characteristics, advantages and particulars of the invention will become more apparent from the additional description given hereafter of the different embodiments given by way of example and with reference to the appended drawings, in which:

FIG. 1 shows a section view of an example of a section according to the invention,

FIG. 2 shows a section view of an example of a portion of pipeline according to the invention,

FIG. 3 shows an S laying diagram,

FIG. 4 shows a J laying diagram,

FIGS. 5, 6 and 7 each show a section view of an example of a section equipped with several connection bases,

FIGS. 8 and 9 show section views of example arrangements of internal electrical heating lines arranged around the internal casing of a section of double-walled pipeline,

FIG. 10 shows a diagram of one example of a single-phase heating circuit,

FIGS. 11 and 12 each show a diagram of an example of a three-phase heating circuit,

FIG. 13 shows an example of a diagram of single-phase heating circuits connected to a three-phase power cable,

FIG. 14 shows an example of a diagram of the electrical heating of a pipeline by heating circuits,

FIG. 15 shows a section diagram of an example of a three-phase power cable connection in parallel to the heating circuits of a section,

FIG. 16 shows a pipeline in which bubbling is being performed to redistribute the heat, and

FIG. 17 shows an example of a process to lay a pipeline according to the invention.

### DETAILED DESCRIPTION OF PREFERRED EMBODIMENTS

The invention will now be described more fully. As indicated previously, a double-walled pipeline of great length is to be built by assembling and welding pipe sections. Each section is, for example, produced separately with its individual heating means and is intended to be powered in parallel by an external cable.

To recreate the context of the invention, reference may be made to patent FR-2721681, FR-2751721 and FR-2758872, which describe the laying techniques for double-walled pipeline sections.

Patent application FR-2721681 firstly describes a process to build pipes such as those used to carry petroleum products offshore and secondly the tubes and tube linking devices used to implement this process. Patent application FR-2751721 firstly describes a process to build pipelines by successively assembling pipes together and secondly pipes for the implementation of this process. Patent application FR-2758872 describe a thermal insulation layer, namely for the building of subsea pipelines carrying petroleum products.

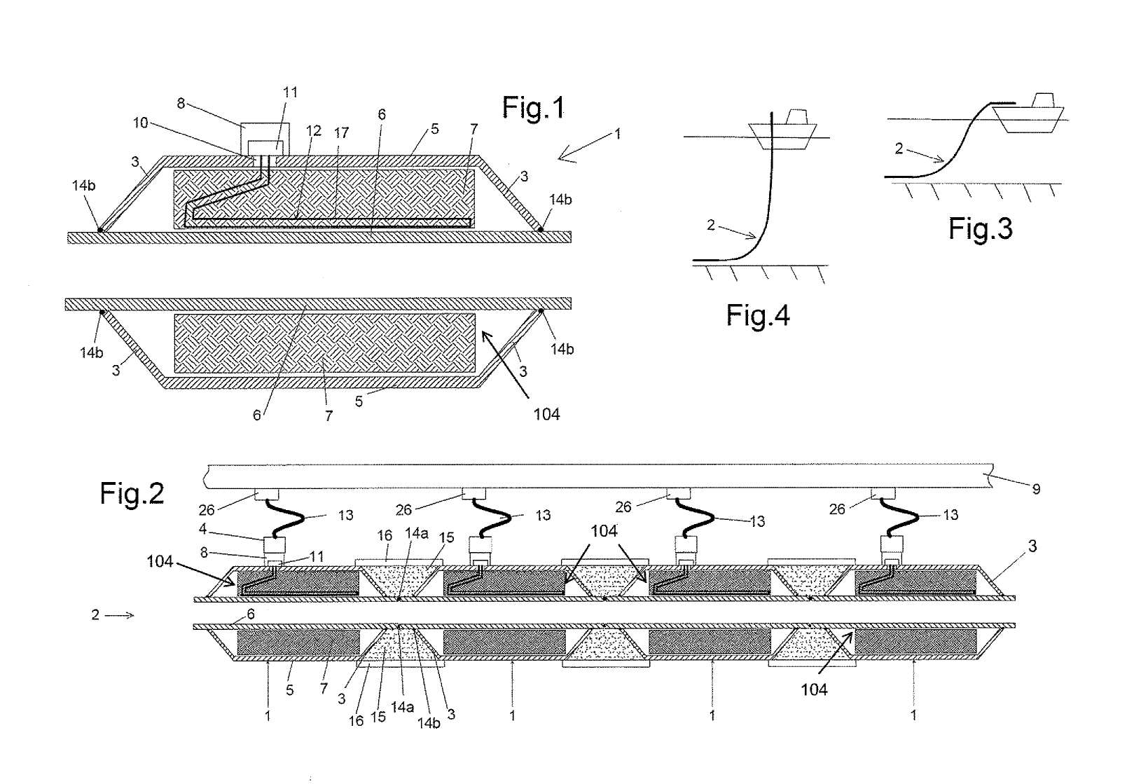

FIG. 1 shows a longitudinal section view of a pipeline section. The section 1 comprises an external casing 5 positioned around an internal casing 6.

The length of a section is, for example in the range of 12 m to 72 m.

The section 1 comprises a thermally insulating material 7 arranged in the annular space 104 between the external casing 5 and the internal casing 6.

A connection base 8 closes and seals an access passage 10 in communication with the annular space 104. The connection base 8 fixed to the external casing 5 of the section 1 is an electrical connection element for electrically connecting with a connection plug 4 linked to a power cable 9, as will be explained later. The connection base 8 will be welded, for example, to the exterior of the external casing 5.

The connection base 8, as shown namely in FIG. 1, protrudes from the external casing 5.

The passage way 10 enables the connection of a heating circuit 12 arranged in the annular space 104. The heating circuit 12 comprises, for example, an electric wire 17.

The connection base 8 is associated with an element 11 cutting off the power in case of a short circuit occurring in said annular space 104. The element 11 cutting off the power is, for example, a switch or a set of fuses cutting off the current for safety reasons in the case of a short circuit or in case of overheating. The current is thus cut off if a short circuit occurs downstream of the connection base 8.

Alternatively, as will be described later, such a power cutting element 26 may also be positioned at the beginning of a branch 13 linked to the external power cable 9. A swaging 3 of the pipe end is performed on the external casing 5 which is thereafter welded to the internal casing 6. The annular space 104 between the external casing 5 and the internal casing 6 is thus closed and sealed by a weld 14b. The swaging 3 of the external casing 5 is made onshore when the sections are being manufactured and before they are loaded onto the laying vessel. The external casing 5, initially tubular, is mechanically swaged so that its ends come into contact with the internal casing 6. The swages 3 are substantially tapered.

The section 1 described in FIG. 1 is a straight section intended to be assembled to form a pipeline according to a laying method called S-lay or J-lay. In an S-lay method as shown in FIG. 3, the sections are positioned horizontally to be joined together to build a pipeline. The S-lay method is generally used for shallow depths. In the J-lay method, shown in FIG. 4, the sections are positioned vertically to be joined together. The J-lay method is generally used for deep depths.

The section 1 shown in FIG. 1 is joined with other sections to form a double-walled pipe 2 such as that shown in FIG. 2. The same references are used in FIG. 1 and in FIG. 2 to designate the same elements.

As shown in FIG. 2, the different sections 1 are joined together by welding. Thus, a weld 14a is made between two internal casing 6 of two consecutive sections. A pipeline 2 may comprise, for example, a few hundred to a few thousand of sections 1. For more clarity, only four sections 1 have been represented in FIG. 2.

A thermally insulating sleeve 16 is slipped over the weld area 14a. The sleeve 16, installed between two sections, covers the two external casings 5 of the sections beyond the swages 3. Thus, the sleeve 16 is arranged radially and at a distance around the weld 14a.

An enclosed space is thus formed under the sleeve 16 between two consecutive sections 1. This volume is delimited by the internal casings 6 extended by the tube swages 3, the sleeve 16 being joined to the bending of the external casing 5 at the base of the two tube swages 3. A quick set material 15 is injected under the sleeve 16, this solidified material 15 increasing the rigidity of the assembly of two sections. Resin is, for example, injected under the sleeve 16.

The connection base 8 of a section 1 is electrically connected by a connection plug 4 linked to a power cable 9. The connection base 8 and plug 4 form an electrical connector. Once connected to the plug 4, the connection base 8 and the plug 4 form a sealed connector that is electrically insulated from the external environment. The power cable 9 is strapped to the pipeline during its installation and is thereby maintained against the pipeline 2. According to professional practice and depending on any accidental external stresses, this power cable may be installed with a mechanical protective structure. Such an accidental external stress is, for example, an impact with an anchor or the hull of a vessel.

The connection base 8 may, for example, be connected sub-sea, the connector is this case being designated by “wet-mate”.

The connection base may also need to be connected in the open air or using a leak-tight enclosure, the connector being in this case designated by “dry-mate”.

Dry-mate type connectors are generally assembled on the deck of the laying vessel, or for the purposes of reparation, a leak-tight enclosure may be installed around the connector.

A wet-mate type connector can be replaced underwater without requiring the installation of a leak-tight enclosure.

Dry-mate connectors, economically more advantageous than wet-mate connectors, are preferred. The connectors previously described are well known in the oil and submarine industries.

After assembly, the heating circuit 12 is electrically connected via the connection base 8 to the external electric power cable 9. The connection base 8 is then electrically connected to a connecting plug 4 arranged at the end of a branch 13.

Heating may be made to maintain a minimal safety temperature or after cooling so as to enable the liquid to circulate by making it fluid by raising its temperature. A minimum temperature in the range of 18 to 25° C. can be maintained so as to avoid the formation of gas hydrates. Heating can also reach 30 or 40° C., or even 60° C. if the formation of paraffin is to be avoided on the internal wall of the main pipe formed by the internal casing 6.

A power cutting element 26 placed at the point of derivation 13 of a branch linked to the external power cable 9 protects against a failure of the branch 13. The current is thus cut off if there is a short circuit downstream of this cutting element 26, for example in the middle of the branch 13.

The different heating circuits 12 of the different sections 1 are parallel linked to the external electric power cable 9. An electrical connection branch 13 is installed between the external power cable 9 and the connection base 8. The heating circuit 12 is electrically linked to connecting elements internal to the connection base 8 so as to form a closed electrical heating circuit for heating the single section 1, when the connection base is powered by the external electric power cable 9. The connecting elements of the connection base 8 are namely brought into contact with connecting elements of the plug 4. The connecting elements of the connection base 8 and the plug 4 are known and are not shown. Thus, a section 1 is individually heated by its heating circuit(s) 12.

However, the heat may also be transmitted from one section to another by convection or by the global movement of the fluids, namely via the mixture of hydrocarbons inside the section 1, for example, in the event of the failure of this heating circuit 12. This is namely possible thanks to the fact that the tubes are efficiently insulated. The tubes are, for example, insulated such that U<1 W/(m².K), or even U<0.5 W/(m².K). U is the power dissipated in the form of heat with respect to the exchange surface and to the difference in temperature. The good insulation obtained by the double-walled structure namely ensures the transmission of heat over a significant distance covering at least one section or even several sections.

In a non-limitative way, temperature sensors could be provided. The sensors are, for example, in communication with an external control line, this line being installed, for example, along the pipeline 2 and being attached to the pipeline 2. The sensors and the control line, not shown, are for example arranged so as to be able to measure the temperature in each section 1 of the pipeline 2 or at each junction between two sections 1 of pipeline 2. The sensors will thus enable operational parameters of the pipeline to be monitored.

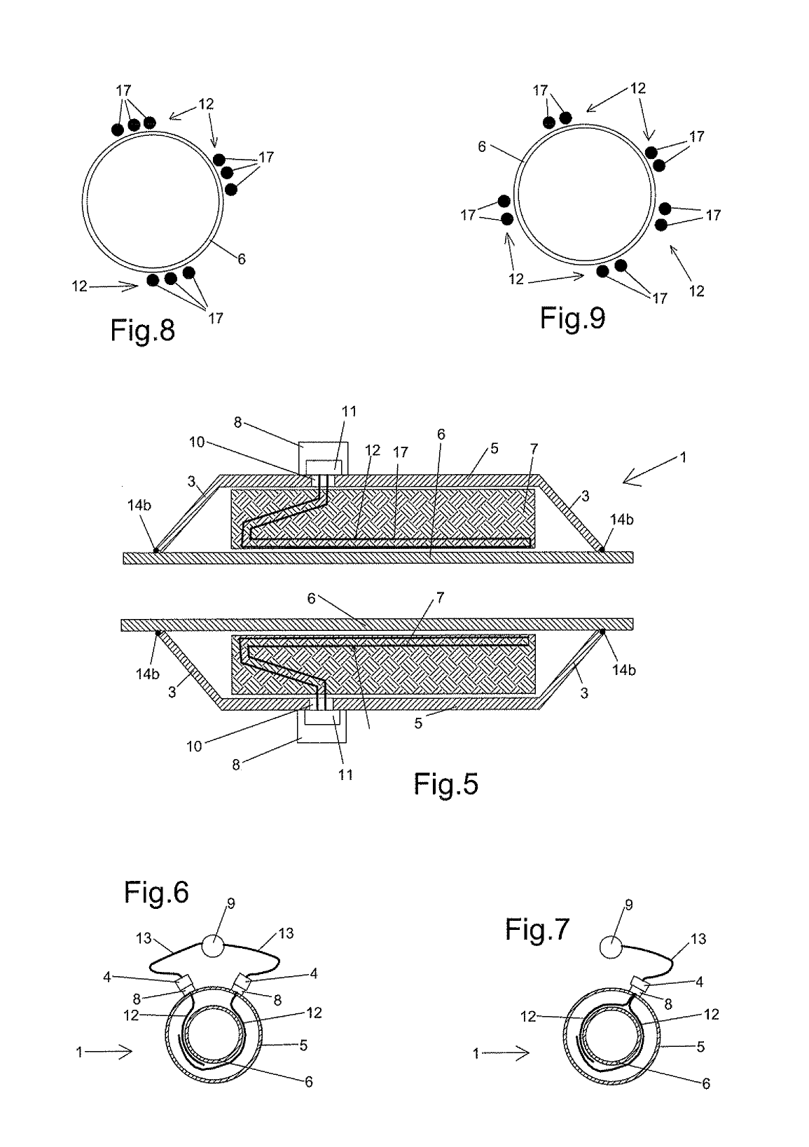

Several connection bases 8 can also be installed on a section 1 as shown in FIGS. 5 and 6. The connection bases 8 are, for example, arranged opposite one another or close to one another. Each connection base 8 is, for example, equipped with a device 11 to cut off the power supply. Each connection base 8 namely closes an access passage 10 in communication with the space 104 arranged between the external casing 5 and the internal casing 6.

A connection base 8 can thus be used to electrically connect one or several heating circuits 12 to the external electric power cable 9.

As shown in FIGS. 5, 6 and 7, additional heating circuits 12 can be arranged redundantly for heating a single section.

Several heating circuits 12 are, for example, electrically connected to the external power cable 9 by the same connection base 8, as shown in FIG. 7.

These additional heating circuits 12 namely enable the electrical heating for the section 1 to be made redundant. Thus, if one electric wire 17 is broken, the section 1 receives heating energy by a remaining heating circuit 12.

A redundancy is provided, for example, by using three heating circuits, as shown in FIG. 8. In FIG. 9, a redundancy is provided by five heating circuits 12. The number of electrical heating wires 17 or heating circuits 12 in a section 1 can be reduced or increased according to need without any particular difficulty.

In a non-limitative way, the heating wires 17 can be positioned along the internal casing 6, as shown in FIGS. 5, 8 and 9, or be wound around the internal casing 6, as shown in FIGS. 6 and 7.

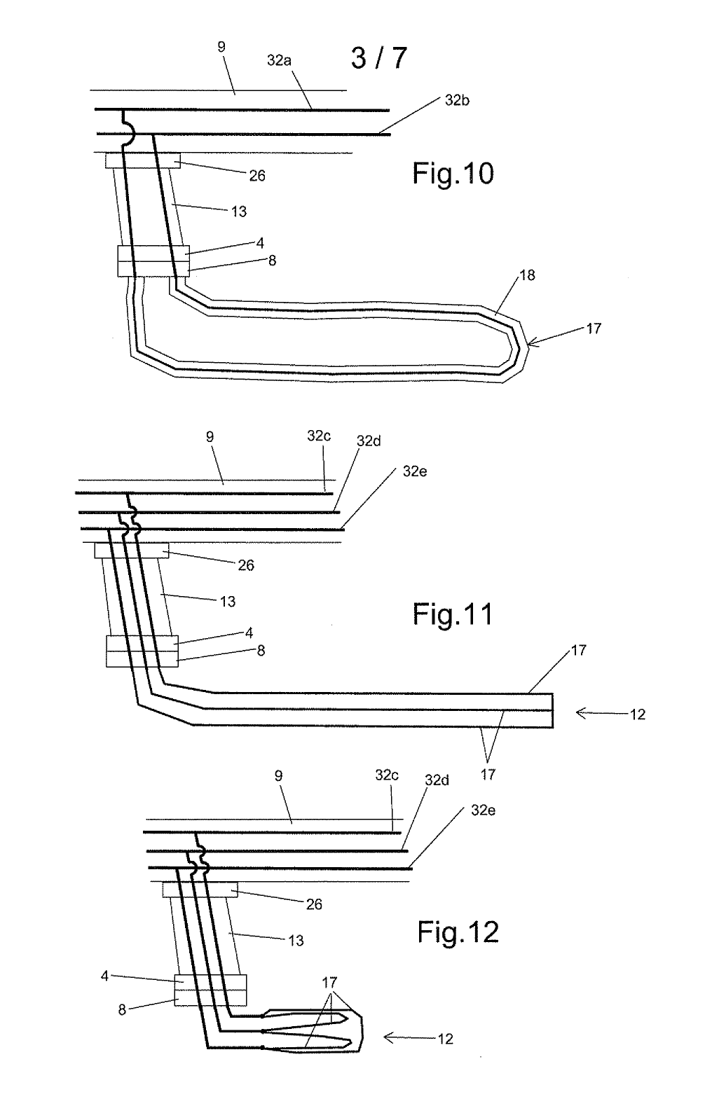

FIGS. 10, 11 and 12 show several possible electrical circuitries. Heating is made by Joule effect, the electric wires 17, through which a current passes, supplying heat.

As shown in FIG. 10, an electric wire 17 forming the heating circuit 12 is electrically insulated from the external casing 5 and from the internal casing 6. An electric wire namely comprises an electrically insulating sheath 18. The wire 17 forms a heating loop for heating by Joule effect and is powered by the single-phase type external power cable 9. The external power cable 9 comprises two power lines 32a and 32b connected by safety or connecting elements to the loop formed by the heating line 17. A safety element 26 is namely positioned at the beginning of the branch 13. The connection of the plug 4 and of connection base 8 enables an electrical connection between the heating wire 17 and the power lines 32a and 32b.

According to FIG. 11, a heating circuit 12 comprises three electric heating wires 17. These three electric wires 17, linked together according to a star assembly, are intended to be powered by the external three-phase power cable 9. The lines 32c, 32d and 32e, each supplying one phase of a three-phase power, are electrically connected to the heating circuit 12 by safety elements 26 or connecting elements 13, 4 and 8. The three heating wires 17 are each connected to a separate phase.

A delta assembly shown in FIG. 12 is powered by an external three-phase power cable 9. As in FIG. 11, the power cable 9 comprises three lines 32c, 32d and 32e each supplying one phase of a three-phase electric power. Each of heating wires 17 is linked to two of the three power lines 32c, 32d and 32e.

Contrary, for example, to what is described in patent EP1641559, the transport of energy and heating is ensured by separate elements. That is to say that the heating function by Joule effect and the electric power supply function are not performed by the same electric lines but by separate electric lines.

An high ratio between the resistance of the heating lines 17, also called heating wires, and the resistance of the power lines of the external power cable 9 advantageously enables the optimization of the loss of energy due to the transportation of the electricity and the dissipation of equal heating power in each section 1. Thus, the voltage drop is to be minimized in the power cable 9.

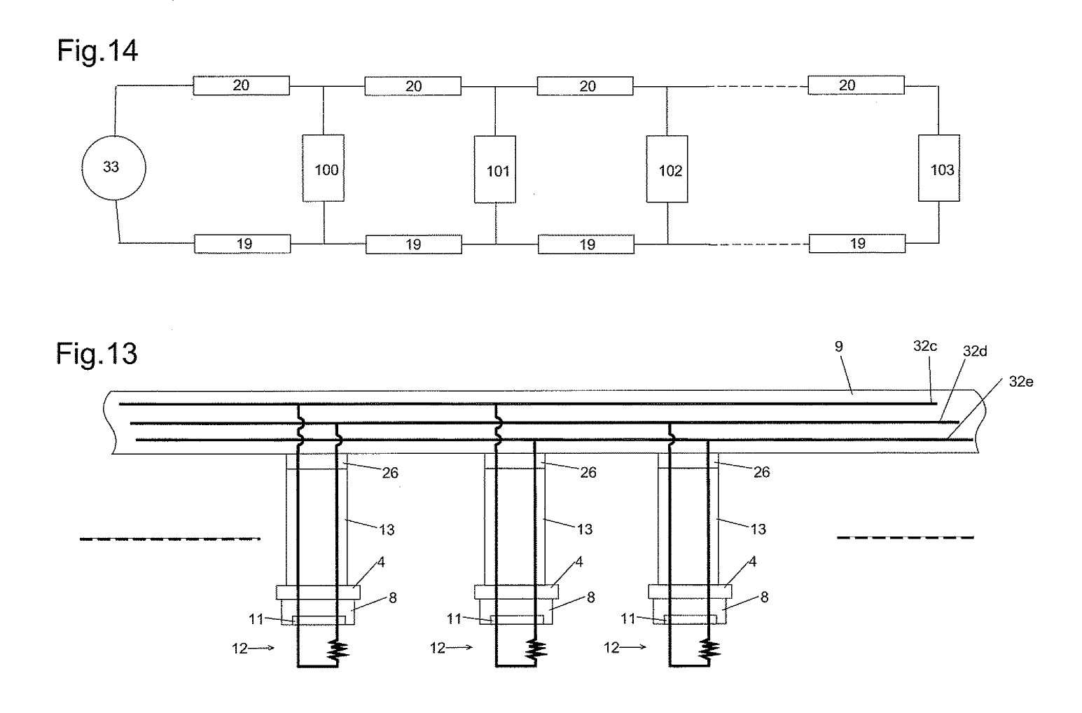

As shown in FIG. 13, the three phases of an electric power cable 9 can be used successively two by two so that the assembly is globally balanced. A first section is, for example, powered by the first and second phases, a second section being powered by the first and third phases and a third section being powered by the second and third phases and so on for the following sections. The heating circuits 12 are electrically connected to the power lines 32c, 32d and 32e by connecting elements 13, 4 and 8 and by safety elements 26 and 11.

The wiring diagram in FIG. 14 represents the heating impedances in each section 1, referenced 100, 101, 102 and 103, arranged with impedances 19 and 20 of the portions of the power lines of the external cable 9. A single-phase or three-phase generator 33 supplies the external electric power cable 9.

In FIG. 14 the example of a single-phase power cable 9 with two supply lines is given in a non-limitative way. The two lines have, for example, identical or different impedances 19 and 20. Identical impedances are, for example, due to the fact that the electric power lines are identical.

The power lines may also be different, for example in terms of their diameter, and the cable lines will thus have different impedances.

The electrical circuitry may be further optimized by adjusting the electrical resistance of the electrical heating circuit 12 in each of the sections such that the heating circuits installed close to a generator 33 supplying the power cable 9 have higher resistance than heating circuits 12 more distant from the generator. Impedances 100, 101, 102 and 103 progressively decrease, for example, the first impedance 100 being greater than the last one 103. The heating circuits installed at a distance from the generator 33 supplying the power cable 9 therefore have less resistance than the heating circuits installed closer to this power generator 33, and may produce the same heating power. Indeed, the voltage in the sections supplied by the power cable 9 decreases because of the cable's own resistance. The resistances of the heating circuits may be reduced according to the drop in voltage in the power cable so as to obtain a constant dissipated power in each of the sections.

The resistance can change between two consecutive sections or, more practically considering the building, by groups of one hundred sections, for example.

The ratio of heating resistances between the closest section and the most distant section powered by the same external power cable 9 will be typically of 5 for 1 or even of 2 for 1, this ratio being taken greater than or equal to 1.

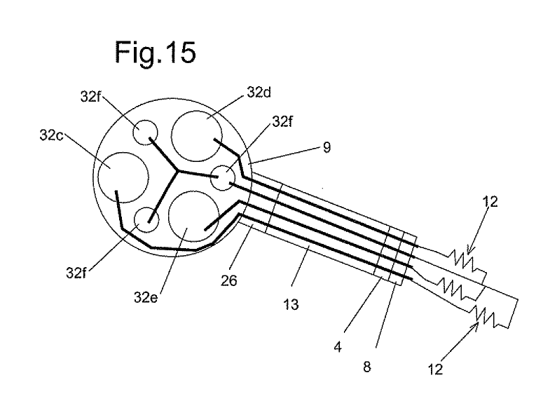

FIG. 15 shows an external power cable 9 comprising three power lines 32c, 32d and 32e each supplying a different phase of the three-phase power supply and three lines 32f for the neutral of the three-phase power supply. The section comprises, for example, several single-phase heating circuits 12 supplied firstly by a distinct phase and each connected secondly to the neutral. The single-phase heating circuits are connected together and to the neutral, the return by the neutral can be eliminated, for example, if the assembly, comprising these three circuits, is balanced. A safety element 26 is provided, for example, in addition to the connection elements 13, 4 and 8.

The sections of the heating wires are, for example, in the range of 0.1 to 1 mm² and are made of resistive alloys, such as, for example chromium and nickel alloy or an iron, chromium and aluminium alloy. The external electric power cable 9 is, however, designed to minimize voltage loss and will thus be manufactured with large section conductive lines of copper or aluminium, typically of 100 to 1000 mm². The ratio between the resistance of the heating circuit and the resistance of a portion of external electric power line arranged between two connectors of two adjacent sections is, for example, of 10⁵ to 10⁹. A mean ratio of 10⁷ is, for example, selected for a pipe comprising different heating resistances according to the distance of the heating circuit with respect to the power generator.

Efficient power voltage of the main cable is, for example, less than 10 kV or even less than 3 kV. Generally speaking, the magnitudes of current, voltage or wattage supplied in the description are efficient magnitudes.

The external electric power line gives, for example, a power supply less than 1 MWatt to maintain a 400 mm diameter pipe at 20° C., over a distance of more than 10 km, with thermal insulation of 0.5 W/(m².K) and in an environment of 4° C. A 48 m section such as described above is, for example, maintained at 20° C. by a power of 500 Watts.

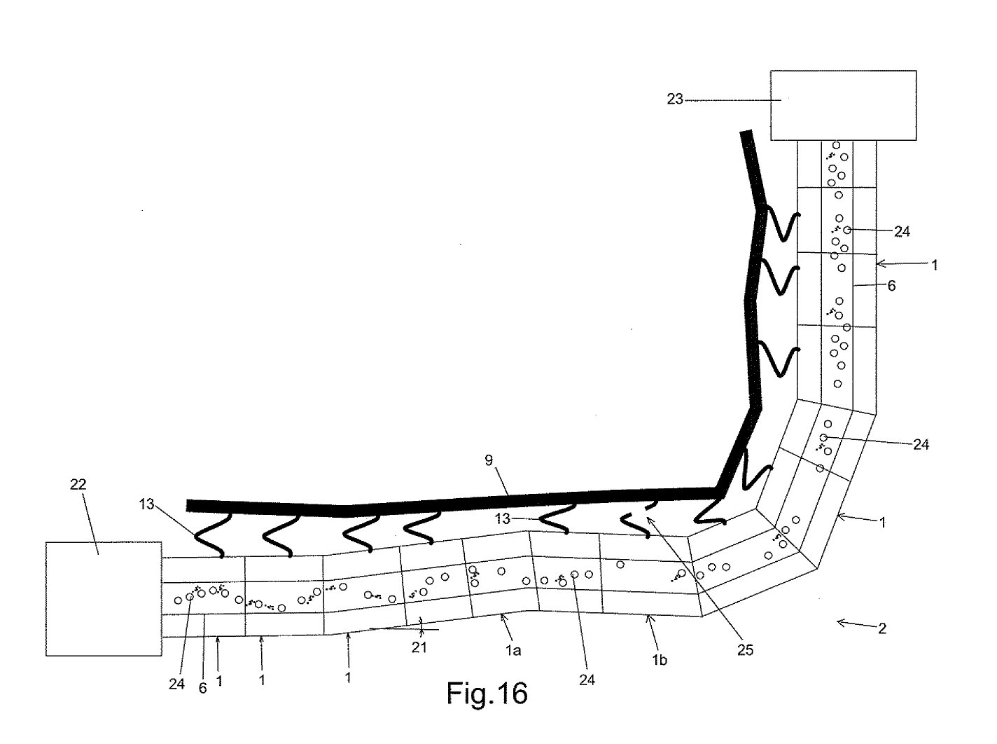

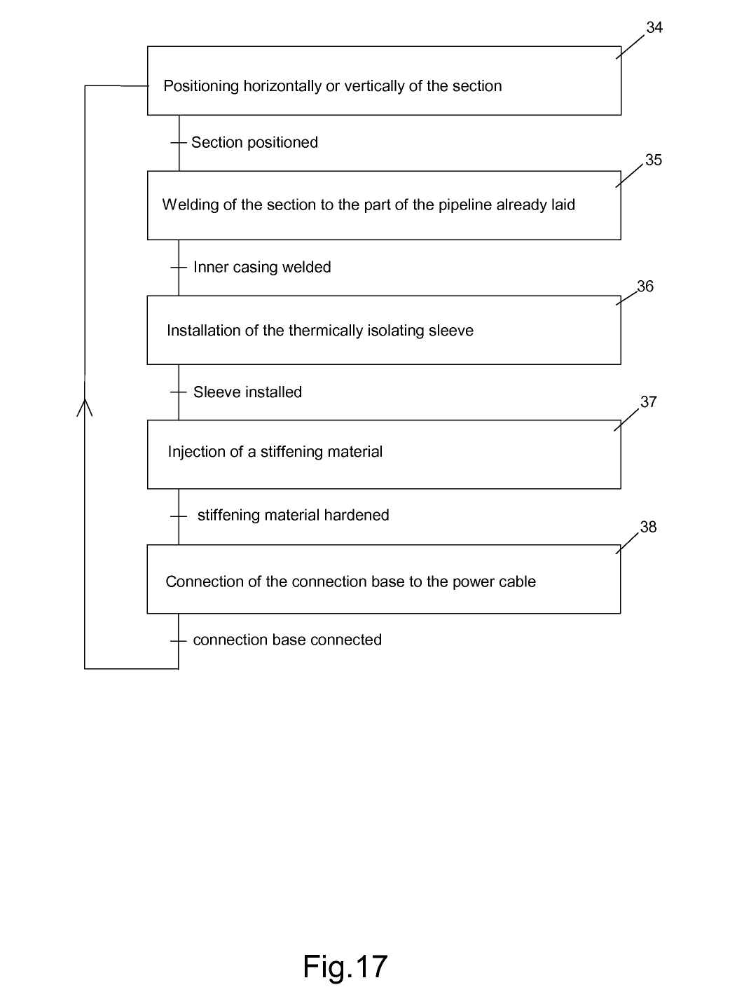

FIG. 16 shows a double-walled pipeline 2 for the transport of hydrocarbons comprising a plurality of sections 1 each heated by its own heating circuit. The hydrocarbon transport pipeline 2, which is composed of sections welded together on a laying vessel, may be composed of sections that are all equipped with a heating circuit that is powered via a connection base 8, or else some sections may not be heated, the heat spreading through two neighboring sections as explained previously.

One section 1a is, for example, without any heating circuit. The heating circuit of a section 1b is, for example, not supplied with energy. A fault 25 causing an electrical breakdown is, for example, shown in the diagram by a broken branch 13.

If there is a heating breakdown or if one section does not comprise any heating means, the heating of the non-heated section may be made using the adjacent heated sections.

When the liquid stagnates inside the pipeline, an inclination 21 of the pipeline enables natural convection heating, for example, when the liquid is heated in a neighboring section below the non-heated section 1a.

When the hydrocarbons circulate in the double-walled pipeline 2, heat transfer is produced by the fluid in motion.

Bubbling can also be performed to cause the liquid to circulate through the pipe. The hydrocarbon inlet valve 22 and the hydrocarbon outlet valve 23 on the operational platform are, for example, opened briefly to allow gas 24 to be introduced into the internal casing of the pipeline 2. The gas 24 circulating in the internal casing stirs up the liquid thereby spreading the heat.

The sealed sections 1 advantageously enable the annular space 104, arranged between the internal casing 6 and the external casing 5, to be pressurized at a predetermined pressure optimized for thermal insulation. Such pressurization is namely facilitated because of the reduced length of the sealed sections. A pressure optimized for thermal insulation is, for example, less than atmospheric pressure. The insulation used is, for example, a microporous material. Pressurization is made, for example, before the sections are loaded onto the laying vessel, during their manufacture.

Thus, laying by the S-lay or J-lay method of a double-walled pipeline comprises a step 34 in which a section is positioned horizontally or vertically.

After its positioning, a fixing step 35 occurs. The internal casing of the section is welded to that part of the pipeline having already been installed.

After the section has been secured in place, there is an operation 36 of installing a thermally insulating sleeve. This sleeve advantageously enables heat loss to be reduced at the junction of two sections.

After the sleeve has been put in place, there is, for example, a step 37 of injecting a stiffening material. The stiffening material is, for example, quick set resin. This enables any variation in stiffness at the junction of two sections to be compensated. The filling material is, for example, polyurethane or an epoxy-type resin or concrete.

After the stiffening material has solidified, there is a step 37 of connecting of the connection base 8 of the section 1 to the external electric power cable 9, via a plug 4 at the end of a branch 13. Several connection bases 8 can also be connected to several plugs 4 if the section is provided with several connection bases 8.

Another step 34 of positioning another section is, for example, performed and the laying of the pipeline continues, the sections being successively connected in parallel to the external power cable 9.

It must be obvious for one skilled in the art that the present invention enables different variant embodiments. Consequently, the present embodiments must be considered as illustrating the invention defined by the enclosed Claims.

What is claimed is:

1. A section of a pipeline for the transport of hydrocarbons that is adapted to a sub-sea environment, said section being constituted by at least one double casing comprising one external casing and one internal casing between which an annular space is arranged and comprising a thermally insulating material, wherein said section comprises at least one heating circuit arranged in said annular space and a connection base fixed to said external casing and intended to a connection plug linked to an external electric power cable, said connection base closing an access passage in communication with said annular space, said heating circuit being electrically powered by said connection base forming a closed heating electrical circuit to heat said section.

2. Section according to claim 1, wherein said section is adapted for the pipeline to be installed according to the S-lay or J-lay method.

3. Section according to claim 1, wherein said annular space is closed and sealed.

4. Section according to claim 3, wherein said annular space is pressurized at a predetermined pressure level optimized for thermal insulation.

5. Section according to claim 4, wherein said annular space is pressurized to said optimized predetermined pressure at a pressure level less than the atmospheric pressure.

6. Section according to claim 1, wherein said heating circuit arranged in said annular space of said section is intended to be powered in parallel by the electric power cable external to the section.

7. Section according to claim 1, wherein said heating circuit comprises a heating loop for heating by Joule effect and intended to be powered in single-phase mode by the external power cable.

8. Section according to claim 1, wherein said heating circuit comprises three heating lines delta or star connected to each other and powered in three-phase mode by the external power cable.

9. Section according to claim 1, wherein said section is intended to be assembled by welding the internal casing, with two adjacent sections, its heating circuit enabling a zone around this weld to be heated by conduction.

10. Section according to claim 1, wherein said connection base is associated with an element to cut the power supply in case of a short circuit occurring in said annular space.

11. Section according to claim 1, further comprising redundant heating circuits to exclusively heat said section, these heating circuits being electrically powered by said connection base or by several connection bases associated with several access passages in communication with the annular space, each of these connection bases closing one of these passages.

12. Section according to claim 1, wherein said heating circuit requires a power supply in the range of 5 to 50 W/m² to maintain the temperature of said section.

13. Section according to claim 1, wherein the thermal exchange coefficient of the section is in the range of 0.1 to 2 W/(m².K).

14. A pipeline for the transport of hydrocarbons composed of straight sections welded together on a laying vessel, wherein said pipeline comprises a plurality of heated sections according to claim 1, these heated sections comprising their electrical heating circuit connected in parallel to said external electrical power cable.

15. Pipeline according to claim 14, wherein the heat is distributed in the pipeline by means for distributing heat between the heated sections and their neighboring non-heated sections.

16. Pipeline according to claim 14, wherein said connection plug linked to the external power cable is arranged at the end of a branch electrically connected to lines of the external power cable by an element cutting off the power supply in the case of a short circuit downstream of the branch.

17. Pipeline according to claim 14, wherein said external power cable is supplied by a generator, the electrical resistance of the heating circuit in one of the sections having a value that decreases according to its distance from the generator.

18. Pipeline according to claim 14, wherein the external power cable is supplied with a voltage in the range of 5 to 1 kV

19. Process to lay a pipeline according to claim 14, wherein:
a section is positioned horizontally or vertically on a laying vessel,
this section is welded to a part of the pipeline already formed,
a thermally insulating sleeve is slipped over the weld, a quick set stiffening product is injected into a volume located between the two sections and under the sleeve,
said connection base is connected to a branch of the external power cable.
